(19) United States
(12) Patent Application Publication
(10) Pub. No.: US 2016/0010602 A1
(43) Pub. Date: Jan. 14, 2016

(54) Intake Manifold Overpressure Compensation For Internal Combustion Engines

(71) Applicant: Cummins Inc., Columbus, IN (US)

(72) Inventor: Andrew Kitchen, Northamptonshire (GB)

(21) Appl. No.: 14/861,644

(22) Filed: Sep. 22, 2015

Related U.S. Application Data
(63) Continuation of application No. PCT/GB2014/050879, filed on Mar. 20, 2014.

(30) Foreign Application Priority Data
Mar. 27, 2013 (GB) 1305616.3

(51) Int. Cl. F02M 35/10; F02M 35/116

(52) U.S. Cl. CPC F02M 35/10236; F02M 35/116; F02M 35/10275; F02M 35/10216

(57) ABSTRACT

Systems and methods for intake manifold overpressure compensation for internal combustion engines with gaseous induction fuel systems are disclosed. The systems and methods include a connecting element that extends between and fluidly connects the downstream ends of first and second intake manifold banks of the internal combustion engine.

### FIELD OF THE INVENTION

The present invention relates generally to internal combustion engines, and more particularly is concerned with internal combustion engines that are subject to intake manifold overpressure events.

### BACKGROUND

Natural gas and other gaseous fuel induction engines that operate in the range of 1200 to 1800 rpm are considered to be high speed engines. High speed natural gas engines in industrial applications, such as gas compression and power generation, can produce 500 kW to several megawatts of shaft power. Such engines are typically turbocharged and intercooled and can employ twelve or more cylinders arranged in a “V” configuration. This configuration results in a large volume of combustion gases in the intake system, especially on engines where the intake manifold is on the outboard side of the cylinders forming the V-shaped configuration. Since gaseous fuel may be introduced into the air stream at the inlet of the compressor, a highly combustible air-fuel mixture can result throughout the entire intake system. This mixture has the potential to ignite in the intake system upon encountering an ignition source such as a combustion gas from an improperly seated intake valve. Once the air-fuel mixture ignites, the flame will travel extremely rapidly toward the charge air cooler, crossing over into the opposite intake manifold, thus igniting a substantial volume of fuel and leading to an intake manifold overpressure event, which may be called a backfire, that significantly exceeds typical operating pressures.

Combustion causes the gas to expand, which then causes the unburned air/fuel mixture in the rest of the intake manifold to be compressed, hence raising its temperature. The elevated temperature of the air/fuel mixture causes the combustion to occur faster. The combustion therefore accelerates as it travels down the manifold and crosses over to the intake manifold on the other bank, causing the pressure to significantly exceed the typical operating pressures.

A variety of countermeasures have been employed in these engines to withstand potential overpressure events, including building the intake manifold with sufficient thickness of material to withstand potential overpressure. A flame arrestor may also be part of such engines to quench flames.

Other techniques have been used in an attempt to eliminate or reduce overpressure events. For example, timed port injection of fuel has been used with a solenoid at the intake port of every cylinder at a location that is a short distance upstream of the intake valves. Fuel injection takes place only when the exhaust valves are closed and the intake valves are open. This technique significantly reduces the volume of the air-fuel mixture in the intake manifold, which reduces the likelihood of intake manifold overpressure. While this configuration is often used on medium speed gas engines, this configuration adds significant cost and complexity and is seldom used on high-speed gas engines. Furthermore, overpressure events can still occur, such as when an injector malfunction results in a continuous stream of fuel.

Another technique to reduce intake manifold overpressure is to reverse the location of the intake and exhaust manifolds, so that the intake manifold is on the inboard side the “V” configuration of the cylinders and the exhaust manifold is on the outboard side. This configuration significantly reduces the volume and length of the intake manifold, thus minimizing intake manifold overpressure intensity from combustion of the air-fuel mixture. While some engines are capable of using this configuration, other engine configurations do not permit reversing the location of the intake and exhaust manifolds without significant redesign of the engines, potentially compromising operational characteristics and leading to substantial cost burden.

An array of pressure relief valve or burst disks may also be located in strategic locations around the intake manifold. However, in addition to added cost, pressure relief valves may not reseal and burst disks need replacement after an intake manifold overpressure event. Such devices have also been inconsistent in actual operation with variations in actuating pressure, potentially still permitting excessive intake manifold overpressure events.

Some engines may incorporate a combination of the countermeasures discussed above. Regardless of the countermeasures incorporated, the possibility of an intake manifold overpressure event is always present in fuel induction gas engines, especially on engines where fuel is introduced significantly upstream of the intake ports of the cylinders. Thus, there is a need to reduce the severity of fuel ignition events should they occur and limiting the extent of such events.

### SUMMARY

Systems and methods for intake manifold overpressure compensation for internal combustion engines with gaseous fuel induction systems. The systems and methods include a connecting element that extends between and fluidly connects the downstream ends of first and second intake manifold banks of the internal combustion engine. In certain embodiments, the connecting element may further include a flame arrestor. The systems and methods disclosed herein allow the burning gas of a charge flow in the intake system to expand in both directions, thereby mitigating the pressure and temperature rise of the unburned charge flow and therefore lessening the severity of the overpressure event. It also allows the flame to travel in two directions from any point in the intake system, reducing the individual flame path length which may therefore further reduce the severity of the overpressure event. Further embodiments, forms, objects, features, advantages, aspects, and benefits shall become apparent from the following description and drawings.

Various aspects of the systems and methods disclosed herein are contemplated. According to one aspect, an internal combustion engine system includes an engine with a first plurality of cylinders along a first side of the engine and a second plurality of cylinders along a second side of the engine. The system also includes an intake system including a main intake line for providing a charge flow to the engine. The intake system further includes a first intake manifold portion connected to the first plurality of cylinders along the first side of the engine and a second intake manifold portion connected to the second plurality of cylinders along the second side of the engine. The first and second intake manifold portions are also connected to the main intake line upstream of the first and second plurality of cylinders to receive the charge flow therefrom and provide the charge flow to respective ones of the first and second plurality of cylinders. The system includes a connecting element extending between and fluidly connecting the first and second intake manifold portions downstream of the first and second plurality of cylinders.

According to one embodiment, the first and second intake manifold portions extend along an outboard side of respective ones of the first and second plurality of cylinders. In another embodiment, the charge flow comprises air. In a refinement of this embodiment, a fuel source is connected to the main intake line and the charge flow comprises an air and fuel mixture. In yet a further refinement, the fuel source is selected from the group comprising natural gas, methane, propane and hydrogen.

In another embodiment, the first plurality of cylinders is arranged in a V-configuration with the second plurality of cylinders. In yet another embodiment, the connecting element includes a flow passage that defines an inner dimension that is substantially less than an inner dimension of a flow passage of each of the first and second intake manifold portions. In a refinement of this embodiment, the connecting element is connected to each of the first and second intake manifold portions with a bellmouth shaped junction. In another refinement of this embodiment, the connecting element is connected to each of the first and second intake manifold portions with a tapered junction.

In another embodiment, the connecting element includes a flow passage that defines an inner dimension that is substantially the same as an inner dimension of a flow passage of each of the first and second intake manifold portions. In yet another embodiment, the system includes a flame arrestor in a flow passage of the connecting element.

According to another aspect, an internal combustion engine system includes an engine with a first plurality of cylinders along a first side of the engine and a second plurality of cylinders along a second side of the engine. The system also includes an intake system including a first intake manifold portion connected to the first plurality of cylinders along the first side of the engine and a second intake manifold portion connected to the second plurality of cylinders along the second side of the engine. The first and second intake manifold portions each receive a charge flow from an upstream end thereof where the upstream end is located upstream of the first and second plurality of cylinders. The system also includes a connecting element extending between the first and second intake manifold portions downstream of the first and second plurality of cylinders. The connecting element provides a flow passage to allow a burning gas of the charge flow in one of the first and second intake manifold portions to expand into the other of the first and second intake manifold portions in response to an overpressure event.

According to one embodiment, the system includes a flame arrestor in the flow passage of the connecting element. In another embodiment, the charge flow comprises an air and fuel mixture.

In yet another embodiment, the flow passage of the connecting element defines an inner dimension that is substantially less than an inner dimension of a flow passage of each of the first and second intake manifold portions. In a refinement of this embodiment, the connecting element is connected to each of the first and second intake manifold portions with a bellmouth shaped junction. In another refinement of this embodiment, the connecting element is connected to each of the first and second intake manifold portions with a tapered junction. In another embodiment, the flow passage of the connecting element defines an inner dimension that is substantially the same as an inner dimension of a flow passage of each of the first and second intake manifold portions.

According to another aspect, a method for operating an internal combustion engine includes: providing a charge flow to first and second intake manifold portions from an upstream end of the first and second intake manifold portions, wherein the first intake manifold portion is fluidly connected to a first plurality of cylinders along a first side of the internal combustion and the second intake manifold portion is fluidly connected to a second plurality of cylinders along a second side of the internal combustion engine; and passing the charge flow through a connecting element that extends from a downstream end of one of the first and second intake manifold portions to a downstream end of the other of the first and second intake manifold portion in response to a burning gas in the one of the first and second intake manifold portions. In one embodiment, the method further includes arresting a flame of the burning gas in the connecting element.

### BRIEF DESCRIPTION OF THE DRAWINGS

FIG. 1 is a diagrammatic view of a high-speed internal combustion engine and an intake system.

FIG. 2 is a diagrammatic view of a junction of the connecting element with the intake manifold.

FIGS. 3-5 show diagrammatic views of alternate embodiments of the junction of the connecting element with the intake manifold.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

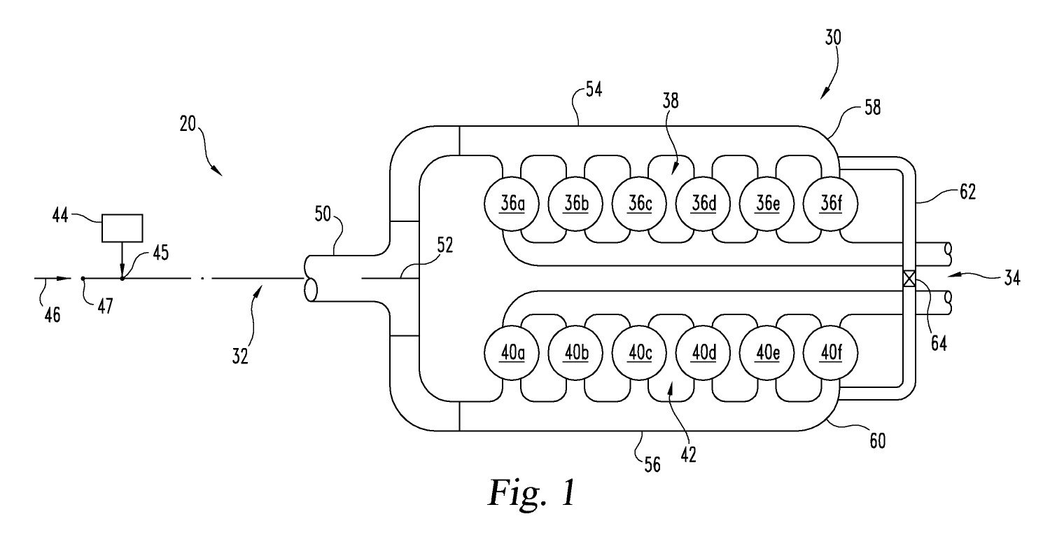

With reference to FIG. 1, a system 20 for producing output power from a gaseous fuel is illustrated in schematic form. System 20 is depicted having an internal combustion engine 30 with an intake system 32 that provides a mixture of charge air and fuel to engine 30, and an exhaust system 34 that outlets the combusted fuel and charge air mixture. The intake system 32 and exhaust system 34 can be fluidly separated systems or connected by one or more exhaust gas recirculation (EGR) systems. The engine 30 is an internal combustion engine of any type that operates with gaseous fuel induction, such as by induction of natural gas, methane, propane and hydrogen based fuels. In the illustrated embodiment, the engine 30 includes twelve cylinders arranged in a V-shaped configuration, with cylinders 36a-36f forming a first cylinder bank 38 along a first side of engine 30 and cylinders 40a-40f forming a second cylinder bank 42 along a second side of engine 30. Such a configuration is typically employed with high speed engines, although the principles discussed herein are not necessarily limited as such. Furthermore, the number of cylinders may be any number, and the arrangement of cylinders may be any arrangement where the intake system 32 is separated into two or more portions to provide flow to multiple cylinder banks.

Intake system 32 is coupled to a fuel source 44 that injects or feeds a fuel to the intake air 46 to form a charge flow that includes an air/fuel mixture to cylinders 36a-36f and cylinders 40a-40f. Intake system 32 includes an intake manifold line 50 that separates at junction 52 to provide a first intake manifold portion 54 to feed a first portion of the charge flow to cylinders 36a-36f and a second intake manifold portion 56 to feed a second portion of the charge flow to cylinders 40a-40f. Intake manifold portions 54, 56 extend along respective ones of the cylinder banks 38, 42 to respective ones of intake portion terminal ends 58, 60. Intake portion terminal ends 58, 60 are located downstream of the last cylinder 36f, 40f of the respective cylinder bank 38, 42 to which the intake manifold portion 54, 56 is connected. A connecting element 62 extends between and fluidly connects first and second intake manifold portions 54, 56 at terminal ends 58, 60.

It is contemplated that engine 30 can be turbocharged and after cooled, with a throttle (not shown), turbocharger (not shown), charge air cooler (not shown) and fuel injection point 45 placed in the intake system 32 anywhere between and including the intake portion 47 and an inlet to a compressor (not shown) of the turbocharger. However, the systems and methods disclosed herein may be used with a non-turbocharged engine 30. Furthermore, first intake manifold portion 54 and second intake manifold portion 56 are shown on the outboard side of the respective cylinder bank 38, 42. The systems and methods disclosed herein may also be employed in an engine 30 with the first and second intake manifold portions 54, 56 positioned on the inboard side of the respective cylinder banks 38, 42.

Combustion of the air/fuel mixture of the charge flow in the intake manifold line 50 and/or intake manifold portions 54, 56 causes the gas to expand and compress the unburned air/fuel mixture in the rest of the intake manifold line 50 and intake manifold portions 54, 56, therefore causing the temperature and pressure of the charge flow to rise. The high temperature results in a faster combustion, so the flame tends to accelerate as it travels in the intake manifold line 50 and/or in the first and second intake manifold portions 54, 56, causing an overpressure event. Connecting element 62 provides a path that lessens the severity of the overpressure event.

The connecting element 62 includes any one of tubing, piping, plumbing, and/or other structures configured to provide a fluid communication between the downstream-most ends of intake manifold portions 54, 56. Connecting element 62 fluidly connects first intake manifold portion 54 with second intake manifold portion 56 and creates a passage that extends between the terminal ends 58, 60 of intake manifold portions 54, 56, allowing for the intake charge flow to travel from one intake manifold portion 54, 56 to the other intake manifold portion 54, 56 in response to an overpressure event. The passage provided by connecting element 62 is in addition to the main intake manifold line 50 that normally feeds the two intake manifold portions 54, 56 with fuel and air mixture from the upstream side of cylinders 36a-36f and 40a-40f. The presence of connecting element 62 allows the charge flow in one intake manifold portion 54, 56 to escape to the other intake manifold portion 54, 56 during an intake overpressure event, which reduces the pressure buildup and therefore the intensity of the combustion. The additional passage provided by connecting element 62 also may allow the flame to pass from one intake manifold portion 54, 56 to the other intake manifold portion 54, 56 during an intake system overpressure event and reduce the individual flame path length to reduce the severity of the overpressure event.

However, since the connecting element 62 also causes the flame to enter the intake manifold portion 54, 56 from two directions instead of one, this may, in some operating conditions, increase the severity of the overpressure event. In this case one or more flame arrestors 64 may be placed inside the connecting element 62 in order to quench the flame and prevent the ignition of the charge flow inside the intake manifold portion 54, 56 on the opposite side from which the flame originated.

The systems and methods disclosed herein can also be employed to dual-fuel or bi-fuel engines 30, which can be converted from existing diesel engines by fumigating natural gas at the compressor inlet, intake manifold or other locations. This allows the engine 30 to substantially reduce the amount of diesel fuel flow, with a typical substitution rate of 50-80%. It is understood that the divided intake manifold 50 will also benefit such dual-fuel or bi-fuel engines.

Furthermore, system 20 is shown with a fuel injection point 45 in the intake system 32 upstream of junction 52. It is further contemplated that system 20 may include an arrangement where the gaseous fuel is injected at each intake port of cylinders 36a-36f and 40a-40f through a timed injection valve. In this arrangement, the intake system 32 normally only contains air and has no combustible fuel. However, an injection valve that becomes stuck in an open condition may cause a continuous stream of fuel to be present in the intake system, resulting in the presence of combustible air/fuel mixture in the intake system such that connecting element 62 has beneficial applications in such systems as well.

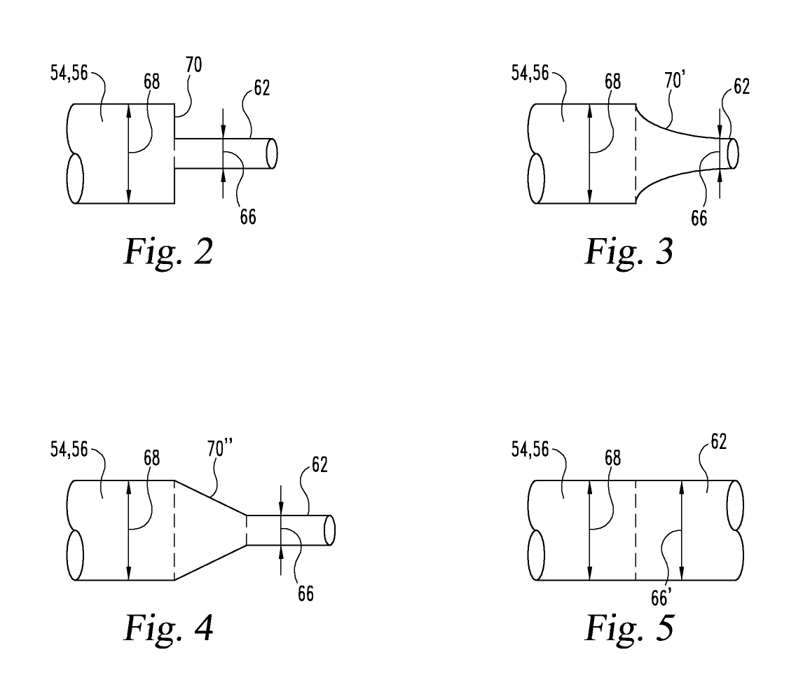

FIG. 2 shows one embodiment of a junction 70 between the intake manifold portion 54, 56 and connecting element 62. Connecting element 62 includes a flow passage with an inner dimension 66 orthogonal to the direction of flow that is significantly smaller than the inner dimension 68 orthogonal to the direction of flow in the flow passage of intake manifold portion 54, 56 adjacent to junction 70. In one embodiment, the inner dimensions are inner diameters of the flow passages; however, non-circular flow passages are also contemplated. The abrupt dimensional change at junction 70 is possible since under normal operating conditions connecting element 62 receives no or little flow from intake manifold portions 54, 56.

However, in a situation where the intake system overpressure event occurs very rapidly, an abrupt dimensional change at junction 70 may impede the balancing of the charge flow between intake manifold portions 54, 56, thereby limiting the effectiveness of connecting element 62 in reducing the severity of the overpressure event. FIG. 3 shows another embodiment junction 70′ which includes a bellmouth configuration connecting intake manifold portion 54, 56 to connecting element 62. FIG. 4 shows an embodiment in which junction 70″ includes a tapered, frusto-conical configuration connecting the intake manifold portion 54, 56 to connecting element 62. The bellmouth and tapered configurations of junctions 70′, 70″ provide a smoother transition than junction 70 from the intake manifold portion 54, 56 to connecting element 62 to minimize the entry loss of the charge flow into connecting element 62.

In the embodiments of FIGS. 3 and 4, the charge flow through connecting element 62 is still restricted by inner dimension 66 of connecting element 62. In still another embodiment shown in FIG. 5, the connecting element 62 has the same inner dimension 66′ as the inner dimension 68 of the respective intake manifold portion 54, 56. This eliminates any abrupt transition between connecting element 62 and intake manifold portions 54, 56 and any restriction in flow through connecting element 62 from intake manifold portions 54, 56.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. An internal combustion engine system, comprising:
an engine including a first plurality of cylinders along a first side of the engine and a second plurality of cylinders along a second side of the engine;
an intake system including a main intake line for providing a charge flow to the engine, the intake system further including a first intake manifold portion connected to the first plurality of cylinders along the first side of the engine and a second intake manifold portion connected to the second plurality of cylinders along the second side of the engine, the first and second intake manifold portions further being connected to the main intake line upstream of the first and second plurality of cylinders to receive the charge flow therefrom and provide the charge flow to respective ones of the first and second plurality of cylinders; and
a connecting element extending between and fluidly connecting the first and second intake manifold portions downstream of the first and second plurality of cylinders.

2. The system of claim 1, wherein the first and second intake manifold portions extend along an outboard side of respective ones of the first and second plurality of cylinders.

3. The system of claim 1, wherein the charge flow comprises air.

4. The system of claim 3, further comprising a fuel source connected to the main intake line and the charge flow comprises an air and fuel mixture.

5. The system of claim 4, wherein the fuel source is selected from the group comprising natural gas, methane, propane and hydrogen.

6. The system of claim 1, wherein the first plurality of cylinders are arranged in a V-configuration with the second plurality of cylinders.

7. The system of claim 1, wherein the connecting element includes a flow passage that defines an inner dimension that is substantially less than an inner dimension of a flow passage of each of the first and second intake manifold portions.

8. The system of claim 7, wherein the connecting element is connected to each of the first and second intake manifold portions with a bellmouth shaped junction.

9. The system of claim 7, wherein the connecting element is connected to each of the first and second intake manifold portions with a tapered junction.

10. The system of claim 1, wherein the connecting element includes a flow passage that defines an inner dimension that is substantially the same as an inner dimension of a flow passage of each of the first and second intake manifold portions.

11. The system of claim 1, further comprising a flame arrestor in a flow passage of the connecting element.

12. An internal combustion engine system, comprising:
an engine including a first plurality of cylinders along a first side of the engine and a second plurality of cylinders along a second side of the engine;
an intake system including a first intake manifold portion connected to the first plurality of cylinders along the first side of the engine and a second intake manifold portion connected to the second plurality of cylinders along the second side of the engine, the first and second intake manifold portions each receiving a charge flow from an upstream end thereof, wherein the upstream end is located upstream of the first and second plurality of cylinders; and
a connecting element extending between the first and second intake manifold portions downstream of the first and second plurality of cylinders, wherein the connecting element provides a flow passage to allow a burning gas of the charge flow in one of the first and second intake manifold portions to expand into the other of the first and second intake manifold portions in response to an overpressure event.

13. The system of claim 12, further comprising a flame arrestor in the flow passage of the connecting element.

14. The system of claim 12, wherein the charge flow comprises an air and fuel mixture.

15. The system of claim 12, wherein the flow passage of the connecting element defines an inner dimension that is substantially less than an inner dimension of a flow passage of each of the first and second intake manifold portions.

16. The system of claim 15, wherein the connecting element is connected to each of the first and second intake manifold portions with a bellmouth shaped junction.

17. The system of claim 15, wherein the connecting element is connected to each of the first and second intake manifold portions with a tapered junction.

18. The system of claim 12, wherein the flow passage of the connecting element defines an inner dimension that is substantially the same as an inner dimension of a flow passage of each of the first and second intake manifold portions.

19. A method for operating an internal combustion engine, comprising:
providing a charge flow to first and second intake manifold portions from an upstream end of the first and second intake manifold portions, wherein the first intake manifold portion is fluidly connected to a first plurality of cylinders along a first side of the internal combustion and the second intake manifold portion is fluidly connected to a second plurality of cylinders along a second side of the internal combustion engine; and passing the charge flow through a connecting element that extends from a downstream end of one of the first and second intake manifold portions to a downstream end of the other of the first and second intake manifold portion in response to a burning gas in the one of the first and second intake manifold portions.

20. The method of claim 19, further comprising arresting a flame of the burning gas in the connecting element.
